(19) United States
(12) Patent Application Publication
(10) Pub. No.: US 2019/0284104 A1
(43) Pub. Date: Sep. 19, 2019

(54) CERAMIC COATING, TURBINE MEMBER, GAS TURBINE, METHOD OF PRODUCING CERAMIC COATING, AND METHOD OF REPAIRING CERMIC COATING

(71) Applicant: MITSUBISHI HEAVY INDUSTRIES, LTD., Tokyo (JP)

(72) Inventors: Shuji Tanigawa, Tokyo (JP); Masahiko Mega, Tokyo (JP); Takumi Bono, Tokyo (JP); Taiji Torigoe, Tokyo (JP); Yoshifumi Okajima, Tokyo (JP); Daisuke Kudo, Tokyo (JP); Hiroyuki Mitsui, Tokyo (JP)

(73) Assignee: MITSUBISHI HEAVY INDUSTRIES, LTD., Tokyo (JP)

(21) Appl. No.: 16/255,193

(22) Filed: Jan. 23, 2019

(30) Foreign Application Priority Data
Mar. 14, 2018 (JP) 2018-046425

(51) Int. Cl. C04B 41/45; C04B 35/48; C04B 41/50; C04B 41/87; C04B 41/00; F01D 5/28; F01D 9/04

(52) U.S. Cl. CPC C04B 41/4588; F05D 2300/20; C04B 41/5042; C04B 41/87; C04B 41/0081; C04B 41/0036; C04B 41/0054; F01D 5/284; F01D 9/041; C04B 2235/3246; F05D 2220/32; F05D 2230/90; F05D 2240/12; F05D 2240/24; C04B 35/48

(57) ABSTRACT

A ceramic coating includes: a ceramic layer; a molten-and-solidified layer formed on a surface of the ceramic layer; and a packed layer including ceramic packed in a crack which extends in a thickness direction of the molten-and-solidified layer.

### TECHNICAL FIELD

The present disclosure relates to a ceramic coating, a turbine member, a gas turbine, a method of producing a ceramic coating, and a method of repairing a ceramic coating.

### BACKGROUND ART

For instance, a power generation apparatus such as a gas turbine is used in a high-temperature environment. Thus, stator vanes and rotor blades of a gas turbine, or a wall material of a combustor, for instance, are formed of heat-resistant members. Further, a thermal barrier coating (TBC) is formed on the basic components made of heat-resistant members to protect the heat-resistant members from high temperature.

For instance, Patent Document 1 discloses a thermal barrier coating including a highly-porous layer formed on a heat-resistant base material, a dense layer formed on the highly-porous layer, and a molten layer on the dense layer where the dense layer is melted.

### CITATION LIST

### Patent Literature

Patent Document 1: WO2017/213113A

### SUMMARY

Meanwhile, a ceramic coating is required to be not transparent to corrosive substances.

Thus, the thermal barrier coating disclosed in Patent Document 1 is provided with a dense layer formed on a highly-porous layer and a molten layer on the dense layer where the dense layer is melted, so as to suppress infiltration of corrosive substances. However, the molten layer may include crack formed therein, which extend in the thickness direction of the molten layer (vertical cracks) due to contraction upon solidification after melting, and the dense layer is also porous. Thus, with the thermal barrier coating described in Patent Document 1, infiltration of corrosive substances may not be sufficiently suppressed, which may lead to degradation of durability.

In view of the above, an object of at least one embodiment of the present invention is to improve durability of a ceramic coating.

(1) According to at least one embodiment of the present invention, a ceramic coating includes: a ceramic layer; a molten-and-solidified layer formed on a surface of the ceramic layer; and a packed layer including ceramic packed in a crack which extends in a thickness direction of the molten-and-solidified layer.

With the above configuration (1), the pores disappear upon melting in the molten-and-solidified layer, and there are almost no remaining pores. Further, even if the molten-and-solidified layer has cracks that extend in the thickness direction due to thermal contraction upon solidification, the cracks are blocked by the packed layer. As described above, with the above configuration (1), the molten-and-solidified layer and the packed layer form a dense layer on the surface of the ceramic layer, and thus it is possible to suppress infiltration of corrosive substances into the ceramic layer with the molten-and-solidified layer and the packed layer. Accordingly, it is possible to improve the durability of the ceramic coating.

(2) In some embodiments, in the above configuration (1), the ceramic layer has a porosity rate of no less than 1% and no more than 30%.

To keep the porosity rate of the ceramic layer under 1%, it is necessary to use an extensive device including a chamber, such as those used in chemical vapor deposition coating. In contrast, if the porosity rate of the ceramic layer is 1% or higher, it is possible to form the ceramic layer by a coating-forming method that does not require a chamber, such as atmospheric plasma spraying. Further, when the porosity rate of the ceramic layer is high, the adhesiveness to the counterpart member on which the ceramic layer is formed tends to decrease. Thus, if the porosity rate of the ceramic layer exceeds 30%, the adhesiveness to the counterpart member on which the ceramic layer is formed may become insufficient.

In this regard, with the above configuration (2), the porosity rate of the ceramic layer is not lower than 1% and not higher than 30%, and thus it is possible to form a ceramic layer having a durability easily

(3) In some embodiments, in the above configuration (1) or (2), the packed layer includes ceramic particles having a 50% cumulative-distribution particle diameter of no more than 5 micrometers.

The size of the gaps of the cracks in the molten-and-solidified layer due to thermal contraction upon solidification is approximately not larger than 10 micrometers, for instance. Thus, with the above configuration (3), with the packed layer including ceramic particles having a 50% cumulative-distribution particle diameter of no more than 5 micrometers, it is possible to improve the packing ratio of the ceramic particles in the cracks, and thus it is possible to improve the sealing effect of the packed layer to block the cracks.

(4) In some embodiments, in any one of the above configurations (1) to (3), the molten-and-solidified layer has a thickness of no less than 5 micrometers and no more than 100 micrometers.

If the thickness of the molten-and-solidified layer is less than 5 micrometers, due to the difference in the thickness upon formation of the molten-and-solidified layer, the thickness becomes extremely small in a particular region and the ceramic layer may become exposed. Thus, the thickness of the molten-and-solidified layer should preferably be 5 micrometers or more. Further, if the thickness of the molten-and-solidified layer exceeds 100 μm, the heat cycle durability of the molten-and-solidified layer may decrease, and thus the thickness of the molten-and-solidified layer should preferably be 100 μm or smaller.

In this regard, with the above configuration (4), the thickness of the molten-and-solidified layer is not smaller than 5 micrometers and not larger than 100 micrometers, and thus it is possible to ensure the heat cycle durability of the molten-and-solidified layer while ensuring the effect to suppress infiltration of the corrosive substances into the ceramic layer.

(5) In some embodiments, in any one of the above configurations (1) to 4), the packed layer includes the same material as the ceramic layer.

If the molten-and-solidified layer is a layer formed by melting and solidifying the surface layer of the ceramic layer, the molten-and-solidified layer and the ceramic layer are formed of the same material. With the above configuration (5), if the molten-and-solidified layer is a layer formed by melting and solidifying the surface layer of the ceramic layer, the ceramic layer, the molten-and-solidified layer, and the packed layer are formed of the same material. Accordingly, the ceramic layer, the molten-and-solidified layer, and the packed layer have the same coefficient of linear expansion and the same phase stability, under a high-temperature environment. Thus, it is possible to suppress quality degradation of the ceramic coating under a high-temperature environment.

(6) In some embodiments, in the above configuration (5), the packed layer and the ceramic layer include yttria-stabilized zirconia.

Among ceramic materials, yttria-stabilized zirconia has a relatively low thermal conductivity and a relatively high thermal expansion rate. Thus, in a case where yttria-stabilized zirconia is used as a ceramic coating material, it is possible to ensure a high thermal barrier performance, and reduce the difference in the thermal expansion rate from the metallic base material. Thus, with the above configuration (6), with the packed layer and the ceramic layer formed of yttria-stabilized zirconia, the ceramic coating is suitable for thermal barrier of the metallic base material, for instance.

(7) According to at least one embodiment of the present invention, a turbine member includes a ceramic coating having any one of the above configurations (1) to (6).

With the above configuration (7), it is possible to improve the durability of the turbine member even under an environment where corrosive substances exist.

(8) According to at least one embodiment of the present invention, a gas turbine includes a turbine member having the above configuration (7).

With the above configuration (8), it is possible to improve the durability of a turbine member of a gas turbine even under an environment where combustion gas contains corrosive substances.

(9) According to at least one embodiment of the present invention, a method of producing a ceramic coating includes: forming a ceramic forming layer; forming a molten-and-solidified layer having a vertical crack by heating and melting a surface layer portion of the ceramic layer and then cooling the surface layer portion; and applying a slurry containing ceramic particles to a surface of the molten-and-solidified layer.

According to the above method (9), if the surface layer portion of the ceramic layer is heated and melted, most of the pores included in the surface layer portion disappear, and thus substantially no pore remains in the molten-and-solidified layer formed as described above. Further, by applying the slurry containing the ceramic particles on the surface of the molten-and-solidified layer, it is possible to introduce the ceramic particles into the cracks (vertical cracks) extending in the thickness direction due to thermal contraction upon solidification of the molten-and-solidified layer, and block the vertical cracks with the ceramic particles.

Thus, according to the above method (9), substantially no pore exists, and the vertical cracks are blocked with the ceramic particles, and thereby the molten-and-solidified layer becomes dense.

Thus, according to the above method (9), it is possible to suppress infiltration of the corrosive substances to the ceramic layer with the dense molten-and-solidified layer Accordingly, it is possible to improve the durability of the ceramic coating.

(10) In some embodiments, the above method (9) further includes supplying the slurry to the vertical crack under a depressurized environment, after the applying of the slurry.

According to the above method (10), it is possible to deaerate the vertical cracks, and supply the slurry efficiently to the cracks.

(11) In some embodiments, the above method (9) or (10) further includes firing the ceramic, particles contained in the slurry existing in the vertical crack, after applying the slurry.

According to the above method (11), by firing the ceramic particles inside the vertical cracks, it is possible to improve the sealing effect of the vertical cracks.

(12) In some embodiments, in the method according to any one of the above (9) to (11), the funning of the molten-and-solidified layer includes heating and melting the surface layer portion of the ceramic layer by emitting any one of laser, electric beam, or plasma.

According to the above method (12), for instance, compared to a case where the surface layer portion of the ceramic layer is heated by using a furnace or the like, it is possible to reduce influence of heat due to heating that affects a region on the inner side of the surface layer portion of the ceramic layer, and it is possible to suppress thermal damage to the ceramic layer.

(13) In some embodiments, in the method according to any one of the above (9) to (12), the forming of the ceramic layer includes forming the ceramic layer having a porosity rate of no less than 1% and no more than 30%.

To keep the porosity rate of the ceramic layer under 1%, it is necessary to use an extensive device including a chamber, such as those used in chemical vapor deposition coating. In contrast, if the porosity rate of the ceramic layer is 1% or higher, it is possible to form the ceramic layer by a coating-forming method that does not require a chamber, such as atmospheric plasma spraying. Further, when the porosity rate of the ceramic layer is high, the adhesiveness to the counterpart member on which the ceramic layer is formed tends to decrease. Thus, if the porosity rate of the ceramic layer exceeds 30%, the adhesiveness to the counterpart member on which the ceramic layer is formed may become insufficient.

In this regard, according to the above method (13), the porosity rate of the ceramic layer is not lower than 1% and not higher than 30%, and thus it is possible to form a ceramic layer having a durability easily.

According to at least one embodiment of the present invention, it is possible to improve durability of ceramic coating.

### BRIEF DESCRIPTION OF DRAWINGS

FIG. 1 is a cross-sectional schematic view of a turbine member including a ceramic coating according to some embodiments.

FIG. 2 is a flowchart showing a process of a method of producing a ceramic coating according to some embodiments.

FIG. 3 is a cross-sectional schematic view of a ceramic coating after forming a ceramic layer on the surface of a bond coat layer in a ceramic-layer forming step.

FIG. 4 is a cross-sectional schematic view of a ceramic coating after forming a molten-and-solidified layer in a molten-and-solidified layer forming step.

FIG. 5 is a cross-sectional schematic view of a ceramic coating after applying slurry on the surface of a molten-and-solidified layer in a slurry applying step.

FIGS. 6A and 6B are diagrams showing the result of analysis on infiltration of corrosive substances to a test piece including a ceramic coating in a filtration test of corrosive substances. FIG. 6A is a diagram showing a result of EPMA analysis on sodium concentration in a cross section of a test piece on which a molten-and-solidified layer having a packed layer is formed, like an embodiment shown in FIG. 1. FIG. 6B is a diagram showing a result of EPMA analysis on sodium concentration in a cross section of a test piece on which a molten-and-solidified layer having a packed layer is not formed, like typical ceramic coating

FIG. 7 is a perspective view of a configuration example of a gas turbine rotor blade.

FIG. 8 is a perspective view of a configuration example of a gas turbine rotor blade.

FIG. 9 is a schematic diagram of a partial cross-sectional structure of a gas turbine according to an embodiment.

### DETAILED DESCRIPTION

Embodiments of the present invention will no be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

(Ceramic Coating)

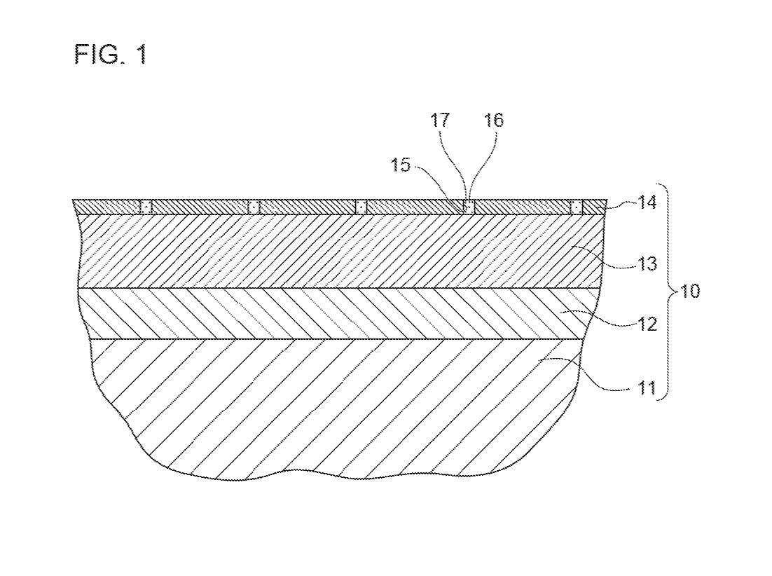

FIG. 1 is a cross-sectional schematic view of a turbine member including a ceramic coating according to some embodiments. In some embodiments described below, as an example of ceramic coating, thermal barrier coating for thermal barrier of a turbine member will be described.

In some embodiments, on a heat-resistant base member (base material) 11 such as a rotor blade and a stationary vane of a turbine, a metallic bond layer (bond coat layer) 12, a ceramic layer 13, and a molten-and-solidified layer 14 are formed in order as a thermal barrier coating. That is, as depicted in FIG. 1, in some embodiments, the ceramic coating 10 is a thermal barrier coating (TBC) layer, which includes the bond coat layer 12, the ceramic layer 13, and the molten-and-solidified layer 14.

The bond coat layer is formed of a McrAIY alloy (M indicates a metallic element such as Ni, Co, and Fe, or a combination of two or more from the above metallic elements) and the like.

In some embodiments, the ceramic layer 13 is formed of YSZ (yttria-stabilized zirconia). Further, the ceramic layer 13 may be formed of any one of YbSZ (ytterbia-stabilized zirconia), SmYbZr₂O₇, DySZ (dysprosia-stabilized zirconia), or ErSZ (erbia-stabilized zirconia).

In some embodiments, the ceramic layer 13 is formed as a porous structure having pores, to ensure the thermal barrier performance. The porosity rate and the thickness of the ceramic layer 13 are set appropriately in accordance with the required thermal conductivity. In some embodiments, the porosity rate of the ceramic layer 13 is not lower than 1% and not higher than 30%.

To keep the porosity rate of the ceramic layer 13 under 1%, it is necessary to use an extensive device including a chamber, such as those used in chemical vapor deposition coating. In contrast, if the porosity rate of the ceramic layer 13 is 1% or higher, it is possible to form the ceramic layer 13 by a coating-forming method that does not require a chamber, such as atmospheric plasma spraying. Further, when the porosity rate of the ceramic layer 13 is high, the adhesiveness to the bond coat layer 12 being the counterpart member on which the ceramic layer 13 is formed tends to decrease. Thus, if the porosity rate of the ceramic layer 13 exceeds 30%, the adhesiveness to the bond coat layer 12 being the counterpart member on which the ceramic layer is formed may become insufficient.

In this regard, in some embodiments, the porosity rate of the ceramic layer 13 is not lower than 1% and not higher than 30%, and thus it is possible to form the ceramic layer 13 having a durability easily.

In the ceramic coating 10 according to some embodiments shown in FIG. 1, the molten-and-solidified layer 14 is formed on the surface of the ceramic layer 13. Further, in the ceramic coating 10 according to some embodiments shown in FIG. 1, the molten-and-solidified layer 14 includes a packed layer 16.

Hereinafter, the molten-and-solidified layer 14 according to some embodiments will be described.

(Molten-and-Solidified Layer 14)

The ceramic coating 10 is required to be not transparent to corrosive substances. In an oil-fired gas turbine or the like that uses an oil fuel, for instance, combustion gas may contain corrosive substances. Specifically, for instance, in an oil-fired gas turbine that uses petroleum oil such as heavy oil as a fuel, combustion gas may contain sodium sulfate (Na₂SO₄) as corrosive substances.

It has been becoming dearer that, in a case where combustion gas contain corrosive substances, corrosive substances infiltrate the ceramic layer 13 through the pores of the ceramic layer 13 of the ceramic coating 10 and degrade the ceramic layer 13, which may lead to a decrease in the durability of the ceramic coating 10.

In the ceramic coating 10 according to some embodiments shown in FIG. 1, the molten-and-solidified layer 14 is formed by heating and melting the surface layer portion of the ceramic layer 13 so that the pores disappear and the molten-and-solidified layer 14 becomes dense, and thereby infiltration of corrosive substances is suppressed.

However, during the process of forming the molten-and-solidified layer 14 on the surface of the ceramic layer 13, cracks (vertical cracks) 15 extending in the thickness direction are formed on the molten-and-solidified layer 14 due to thermal contraction upon solidification after heating and melting. Thus, if no measure is taken, the corrosive substances infiltrate the ceramic layer 13 via the cracks 15.

Further, in the ceramic coating 10 according to some embodiments shown in FIG. 1, the packed layer 16 is formed inside the molten-and-solidified layer 14 to block the cracks 15. Further, in the ceramic coating 10 according to some embodiments shown in FIG. 1, the packed layer 16 includes ceramic packed in the cracks 15.

That is, the ceramic coating 10 according to some embodiments shown in FIG. 1 includes the ceramic layer 13, the molten-and-solidified layer 14 formed on the surface of the ceramic layer 13, and the packed layer 16 including ceramic packed in the cracks 15 that extend in the thickness direction of the molten-and-solidified layer 14.

Accordingly, the pores disappear from the molten-and-solidified layer 14 upon melting, and there are almost no remaining pores. Further, even if the molten-and-solidified layer 14 has cracks 15 that extend in the thickness direction due to thermal contraction upon solidification, the cracks are blocked by the packed layer 16. As described above, in the ceramic coating 10 according to some embodiments shown in FIG. 1, the molten-and-solidified layer 14 and the packed layer 16 form a dense layer on the surface of the ceramic layer 13, and thus it is possible to suppress infiltration of corrosive substances into the ceramic layer 13 with the molten-and-solidified layer 14 and the packed layer 16. Accordingly, it is possible to improve the durability of the ceramic coating 10.

The portion that solidifies after heating and melting in the ceramic coating 10 is harder than the portion that is not heated and melted. In this regard, in the ceramic coating 10 according to some embodiments shown in FIG. 1, the molten-and-solidified layer 14 is formed on the surface of the ceramic layer 13, and thus it is possible to improve the anti-erosion performance of the ceramic coating 10.

Further, the inventors conducted experiments and confirmed that there is no particular difference in the heat cycle durability of the ceramic coating 10 whether there is the packed layer 16 or not.

In the ceramic coating 10 according to some embodiments shown in FIG. 1, the thickness of the molten-and-solidified layer 14 is not smaller than 5 micrometers and not larger than 100 micrometers.

If the thickness of the molten-and-solidified layer 14 is less than 5 micrometers, due to the difference in the thickness upon formation of the molten-and-solidified layer 14, the thickness becomes extremely small in a particular region and the ceramic layer 13 may become exposed. Furthermore, even if the ceramic layer 13 does not become exposed, the effect of the molten-and-solidified layer 14 to suppress infiltration of the corrosive substances may become insufficient. Thus, the thickness of the molten-and-solidified layer 14 should preferably be 5 micrometers or more. Further, if the thickness of the molten-and-solidified layer 14 exceeds 100 μm, the heat cycle durability of the molten-and-solidified layer 14 may decrease, and thus the thickness of the molten-and-solidified layer 14 should preferably be 100 μm or smaller.

In this regard, in the ceramic coating 10 according to some embodiments shown in FIG. 1, the thickness of the molten-and-solidified layer 14 is not smaller than 5 micrometers and not larger than 100 micrometers, and thus it is possible to ensure the heat cycle durability of the molten-and-solidified layer 14 while ensuring the effect to suppress infiltration of the corrosive substances into the ceramic layer 13.

Further, the molten-and-solidified layer 14 and the ceramic layer 13 have different appearances in a cross-section as shown in FIG. 1, due to the difference in the porosity rate, and due to the difference of the molten-and-solidification state. Thus, it is easy to visually discriminate the molten-and-solidified layer 14 from the ceramic layer 13 and determine that the molten-and-solidified layer 14 is a region formed by solidification after melting.

(Packed Layer 16)

Hereinafter, the packed layer 16 according to some embodiments will be described.

In the ceramic coating 10 according to some embodiments shown in FIG. 1, the packed layer 16 includes ceramic particles 17 having a 50% cumulative-distribution particle diameter of no more than 5 micrometers.

The size of the gaps of the cracks 15 in the molten-and-solidified layer 14 due to thermal contraction upon solidification is approximately not larger than 10 micrometers, fix instance. Thus, with the packed layer 16 including ceramic particles 17 having a 50% cumulative-distribution particle diameter of no more than 5 micrometers, it is possible to improve the packing ratio of the ceramic particles 17 in the cracks 15, and thus it is possible to improve the sealing effect of the packed layer 16 to block the cracks 15.

Further, in the ceramic coating 10 according to some embodiments shown in FIG. 1, the packed layer 16 is formed of the same material as the ceramic layer 13.

Since the molten-and-solidified layer 14 is a layer formed by melting and solidifying the surface layer of the ceramic layer 13, the molten-and-solidified layer 14 and the ceramic layer 13 are formed of the same material. Thus, in some embodiments shown in FIG. 1, the ceramic layer 13, the molten-and-solidified layer 14, and the packed layer 16 are formed of the same material. Accordingly, the ceramic layer 13, the molten-and-solidified layer 14, and the packed layer 16 have the same coefficient of linear expansion and the same phase stability, under a high-temperature environment. Thus, it is possible to suppress quality degradation of the ceramic coating 10 under a high-temperature environment.

Further, in the ceramic coating 10 according to some embodiments shown in FIG. 1, the packed layer 16 and the ceramic layer 13 are formed of YSZ (yttria-stabilized zirconia).

Among ceramic materials, yttria-stabilized zirconia has a relatively low thermal conductivity and a relatively high thermal expansion rate. Thus, in a case where yttria-stabilized zirconia is used as a material of the ceramic coating 10, it is possible to ensure a high thermal barrier performance, and reduce the difference in the thermal expansion rate from the metallic base material 11. Thus, with the packed layer 16 and the ceramic layer 13 formed of yttria-stabilized zirconia, the ceramic coating 10 can be suitably used as thermal barrier of the metallic base material 11.

(Method of Producing the Ceramic Coating 10)

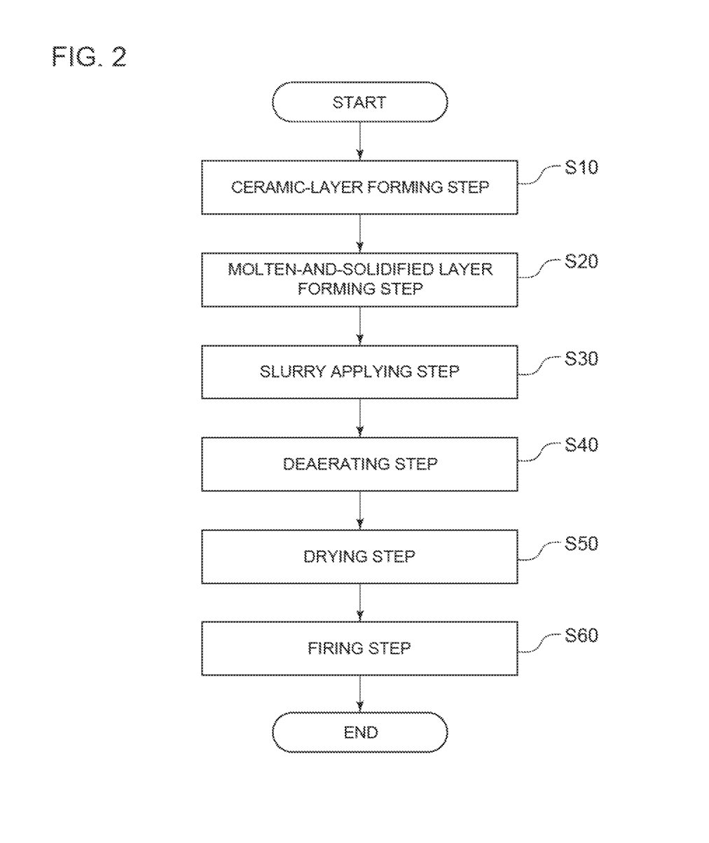

Hereinafter, a method of producing a ceramic coating according to some embodiments will be described. FIG. 2 is a flowchart showing a process of a method of producing a ceramic coating according to some embodiments.

A method of producing a ceramic coating according to some embodiments includes a ceramic-layer forming step S10, a molten-and-solidified layer forming step S20, a slurry applying step S30, a deaerating step S40, a drying step S50, and a firing step S60.

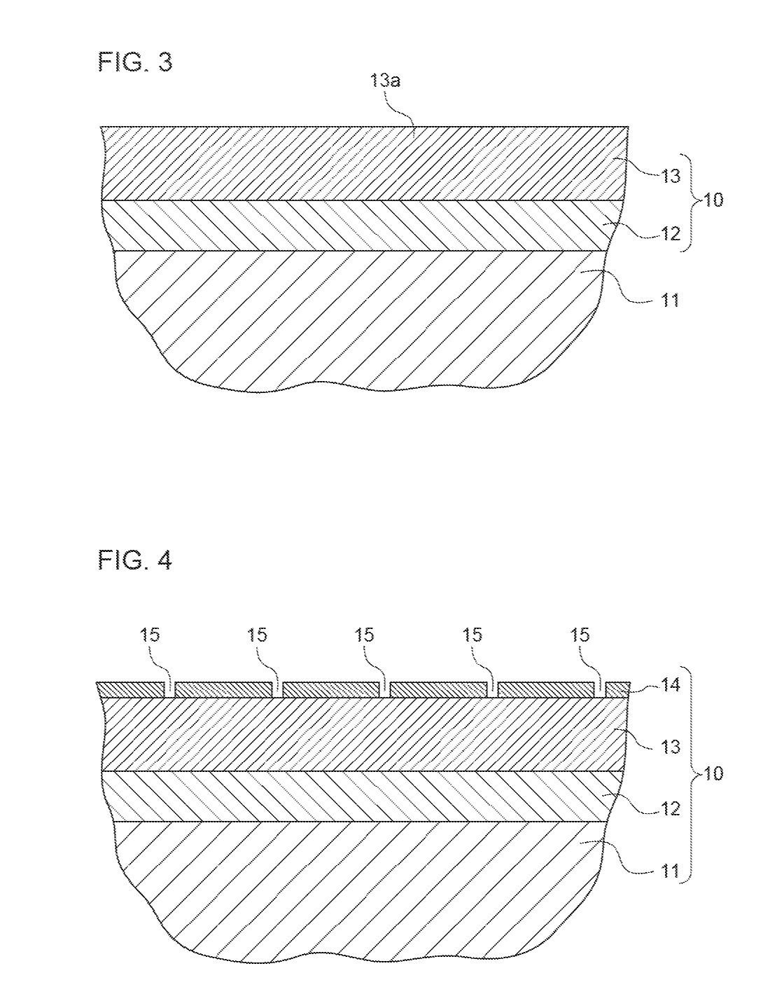

The ceramic-layer forming step S10 is a step of forming the ceramic layer 13, and the ceramic layer 13 is laminated on the bond coat layer 12 formed on the base material 11. In a method of producing ceramic coating according to some embodiments, in the ceramic-layer forming step S10, for instance, YSZ spray particles are emitted onto the surface of the bond coat layer 12 by atmospheric Plasma spraying to form the ceramic layer 13. FIG. 3 is a cross-sectional schematic view of the ceramic coating 10 after forming the ceramic layer 13 on the surface of the bond coat layer 12 in the ceramic layer forming step S10.

Further, in some embodiments, in the ceramic-layer forming step S10, the ceramic layer 13 is formed to have a porosity rate of not lower than 1% and not higher than 30%.

To keep the porosity rate of the ceramic layer 13 under 1%, it is necessary to use an extensive device including a chamber, as described above. In contrast, if the porosity rate of the ceramic layer 13 is 1 or higher, it is possible to form the ceramic layer 13 by a coating-forming method that does not require a chamber, such as atmospheric plasma spraying. Further, as described above, if the porosity rate of the ceramic layer 13 exceeds 30%, the adhesiveness to the bond coat layer 12 being the counterpart member on which the ceramic layer 13 is formed may become insufficient.

In this regard, in some embodiments, the porosity rate of the ceramic layer 13 formed in the ceramic-layer forming step S10 is not lower than 1% and not higher than 30%, and thus it is possible to form the ceramic layer 13 having a durability easily.

The molten-and-solidified layer forming step S20 is a step of forming the molten-and-solidified layer 14 having cracks 15 by heating and melting the surface layer portion 13a of the ceramic layer 13 and then cooling the surface layer portion 13a. FIG. 4 is a cross-sectional schematic view of the ceramic coating 10 after forming the molten-and-solidified layer 14 in the molten-and-solidified layer forming step S20.

In some embodiments, in the molten-and-solidified layer forming step S20, the surface layer portion 13a of the ceramic layer 13 is heated and melted by emitting any one of laser, electronic beam, or plasma.

Accordingly, for instance, compared to a case where the surface layer portion 13a of the ceramic layer 13 is heated by using a furnace or the like, it is possible to suppress influence of heat due to heating that affects a region on the inner side of the surface layer portion 13a of the ceramic layer 13, and it is possible to suppress thermal damage to the ceramic layer 13.

Further, in the molten-and-solidified layer forming step S20, the surface layer portion 13a of the ceramic layer 13 is heated and melted so that the thickness of the molten-and-solidified layer 14 becomes no less than 5 micrometers and no more than 100 micrometers, as described above.

For instance, described below is an example of laser emission conditions in a case where the surface layer portion 13a is heated and melted by laser emission. For instance, the average output is 20 W, the emission speed is 2.4 m/min, and the beam diameter is 0.3 mm. The laser beam may be scanned by using a six-axis robot, or by using a Gralvano lens.

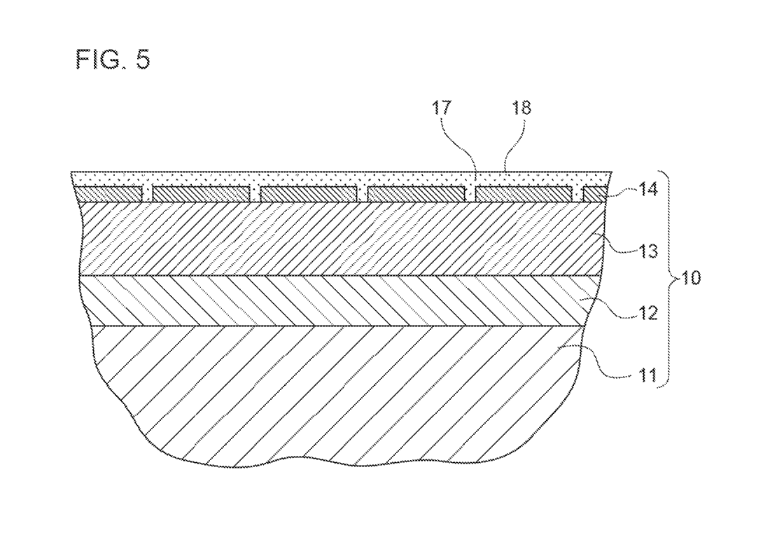

The slurry applying step S30 is a step of applying slurry 18 containing ceramic particles 17 to the surface of the molten-and-solidified layer 14. The molten-and-solidified layer 14 formed as described above includes a plurality of cracks 15. Thus, to caulk the cracks 15, in the slurry applying step S30, slurry 18 containing ceramic particles 17 is applied to the surface of the molten-and-solidified layer 14. FIG. 5 is a cross-sectional schematic view of the ceramic coating 10 after applying slurry 18 to the surface of the molten-and-solidified layer 14 in the slurry applying step S30.

In some embodiments, the ceramic particles 17 contained in the slurry 18 have a 50% cumulative-distribution particle diameter of no more than 5 micrometers. In some embodiments, the particle diameter of the ceramic particles 17 is shown as a value measured by the wet-type light scattering method.

The slurry 18 may have the following composition, for example. For instance, the slurry 18 may include YSZ particles whose 10% cumulative-distribution particle diameter is 0.4 micrometers, 50% cumulative-distribution particle diameter is 0.7 micrometers, and 90% cumulative-distribution particle diameter is 2.1 micrometers, and ethanol and a dispersing agent as solvent. The solid-liquid ratio may be 1:3, or in other words, the concentration may be 25 wt %.

Further, as another example, the slurry 18 may have the following composition.

For instance, the slurry 18 may include YSZ particles whose 50% cumulative-distribution particle diameter is 0.04 micrometers, and water and a dispersing agent as solvent. The solid-liquid ratio may be 1:5, that is, the concentration may be 20 wt %.

The deaeration step S40 is a step of supplying the slurry to cracks 15 under a depressurized environment, after the slurry applying step S30. That is, in the deaeration step S40, the slurry 18 is replaced with air remaining in the cracks 15 by deaerating the air remaining in the cracks 15, in a depressurizing chamber.

Accordingly it is possible to deaerate the cracks 15, and supply the slurry 18 effectively to the cracks 15.

The drying step S50 is a step of heating and drying the slurry 18 applied in the slurry applying step S30. In the drying step S50, after drying the slurry 18, the dried slurry 18 remaining on the surface of the molten-and-solidified layer 14 is polished and removed.

The firing step S60 is a step of firing ceramic particles 17 contained in the slurry 18 existing in the cracks 15, after the slurry applying step S30. In the firing step S60, for instance, the ceramic particles 17 inside the cracks 15 are fired at the temperature of 600° C. or higher.

As described above, by firing the ceramic particles 17 inside the cracks 15, it is possible to improve the effect to seal the cracks 15.

Further, the ceramic particles 17 may be fired in the firing step S60 to such an extent that the pre-firing shape of the ceramic particles 17 can be visually recognizable by breakage observation of the ceramic coating 10, or the ceramic particles 17 may be fired further so that the pre-firing shape of the ceramic particles 17 is no longer recognizable.

Furthermore, the firing step S60 may be performed in the production stage of a member having the ceramic coating 10, or may be performed by utilizing the temperature environment upon usage of the member having the ceramic coating 10. For instance, in a case where the ceramic coating 10 according to some embodiments is formed on a stationary vane of an industrial gas turbine, a stationary vane having an unfired ceramic coating 10 may be attached to a gas turbine, and the ceramic particles 17 contained in the slurry 18 existing in the cracks 15 may be fired by combustion gas generated from operation of the gas turbine.

As described above, the method of producing ceramic coating according to some embodiments includes a ceramic-layer forming step S10, a molten-and-solidified layer forming step S20, and a slurry applying step S30.

In the molten-and-solidified layer forming step S20, if the surface layer portion 13a of the ceramic layer 13 is heated and melted, most of the pores included in the surface layer portion 13a disappear, and thus substantially no pore remains in the molten-and-solidified layer 14 formed as described above. Further, by applying the slurry 18 containing the ceramic particles 17 on the surface of the molten-and-solidified layer 14, it is possible to introduce the ceramic particles 17 into the cracks 15 of the molten-and-solidified layer 14, and block the cracks 15 with the ceramic particles 17.

Thus, according to the method of producing ceramic coating according to some embodiments, substantially no pore exists, and the cracks 15 are blocked with the ceramic particles 17, and thereby the molten-and-solidified layer 14 becomes dense.

Thus, according to the method of producing ceramic coating according to some embodiments, it is possible to suppress infiltration of the corrosive substances to the ceramic layer 13 with the dense molten-and-solidified layer 14. Accordingly, it is possible to improve the durability of the ceramic coating 10.

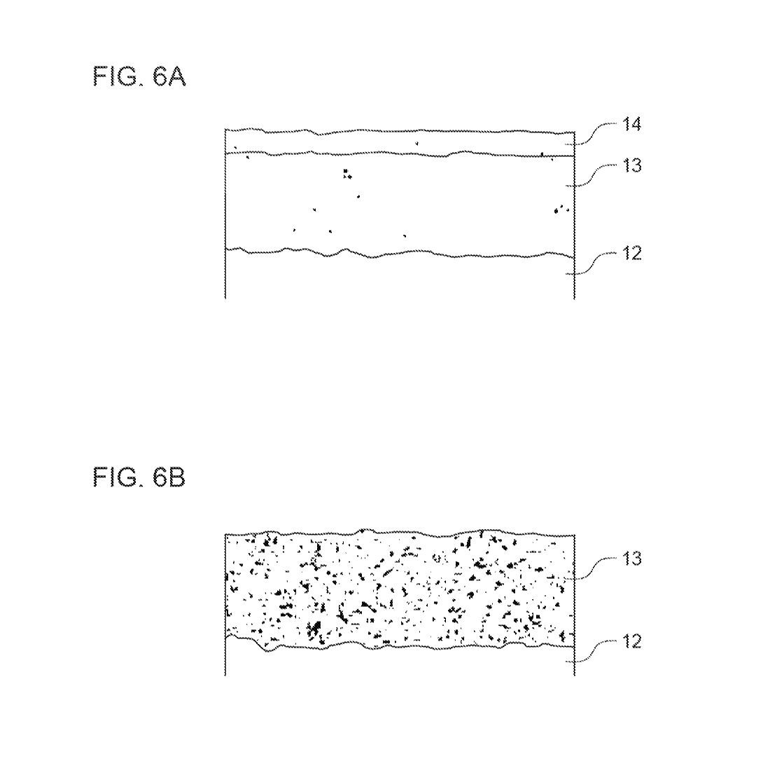

FIGS. 6A and 6B are diagrams showing the result of analysis on infiltration of corrosive substances to a test piece including a ceramic coating in a filtration test of corrosive substances. FIG. 6A is a diagram showing a result of EPMA analysis on sodium concentration in a cross section of a test piece which includes the bond coat layer 12, the ceramic layer 13, and the molten-and-solidified layer 14 having the packed layer 16 formed on the base material 11, like an embodiment shown in FIG. 1. FIG. 6B is a diagram showing a result of EPMA analysis on sodium concentration in a cross section of a test piece which includes the bond coat layer 12 and the ceramic layer 13 formed in order on the base material 11, but not including the molten-and-solidified layer 14, like typical ceramic coating. Further, in FIGS. 6A and 5B, regions where the sodium concentration is equal to or higher than a predetermined concentration are shaded black, to make the drawings easier to understand.

As depicted in FIG. 6A, in a test piece on which the molten-and-solidified layer 14 including the packed layer 16 is laminated on the ceramic layer 13, sodium is substantially not infiltrating the ceramic layer 13.

In contrast, as depicted in FIG. 6B, in a test piece on which the molten-and-solidified layer 14 is not laminated on the ceramic layer 13, sodium is infiltrating the ceramic layer 13.

(Turbine Member and Gas Turbine)

The ceramic coating 10 according to some embodiments described above is suitably applicable to rotor blades and stationary vanes of an industrial gas turbine, or high-temperature components such as combustors and transition pieces of a combustor. Further, the ceramic coating 10 can be applied not only to an industrial gas turbine but also to a thermal barrier coating layer of a high-temperature part of an engine of an automobile or a jet, for instance. By providing the above members with the ceramic coating 10 according to some embodiments described above, it is possible to obtain gas turbine blades and high-temperature members having a high anti-corrosion property.

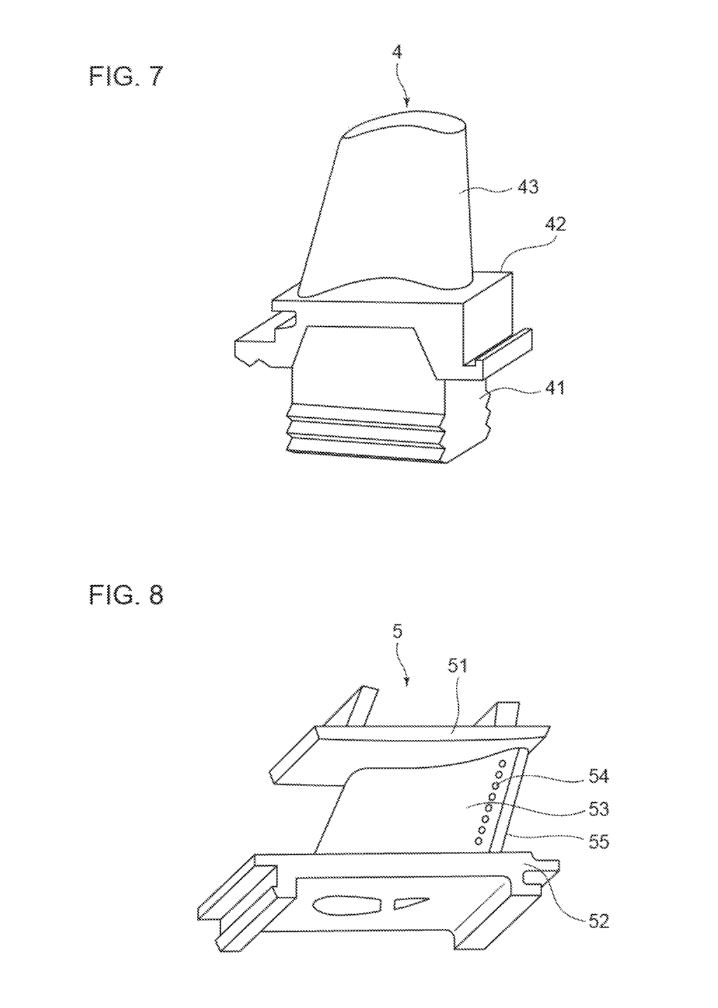

FIGS. 7 and 8 are each a perspective view of a turbine blade being a turbine member to which the ceramic coating 10 according to some embodiments can be applied. The gas turbine rotor blade 4 shown in FIG. 7 includes a dovetail 71 to be fixed to a disc side, a platform 42, and a blade portion 43, for instance. Further, the gas turbine stationary vane 5 depicted in FIG. 8 includes an inner shroud 51, an outer shroud 52, and a blade portion 53. A seal-fin cooling hole 54 and a slit 55 are formed on the blade portion 53, for instance.

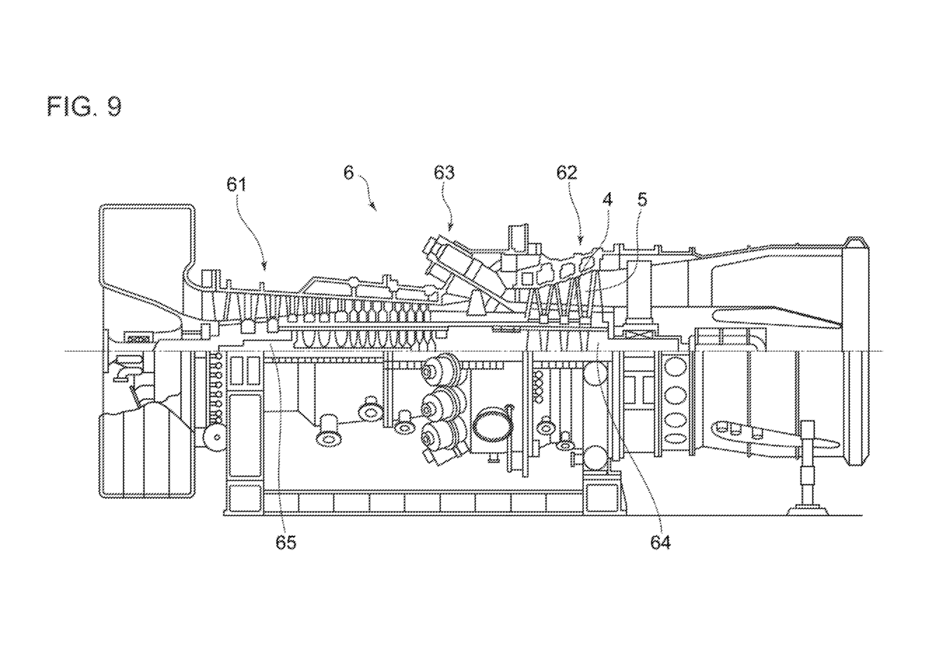

Next, a gas turbine to which the turbine blades 4, 5 shown in FIGS. 7, 8 can be applied will be described below with reference to FIG. 9. FIG. 9 is a schematic diagram of a partial cross-sectional structure of a gas turbine according to an embodiment. The gas turbine 6 includes a compressor 61 and a turbine 62 coupled directly to one another. The compressor 61 is configured as an axial-flow compressor, for instance, and takes in atmosphere or a predetermined gas from an intake port as a working fluid and increases the pressure. A combustor 63 is connected to the outlet of the compressor 61, and the working fluid discharged from the compressor 61 is heated to a predetermined turbine inlet temperature by the combustor 63. Further, the working fluid having its temperature increased to a predetermined temperature is supplied to the turbine 62. As depicted in FIG. 9, inside the casing of the turbine 62, a plurality of stages of gas turbine stationary vanes 5 described above are provided. Further, the above described gas turbine rotor blades 4 are mounted to a main shaft 64 so as to form a pair of stages with each of the stationary vanes 5. An end of the main shaft 64 is connected to the rotational shaft 65 of the compressor 61, and the other end of the main shaft 64 is connected to the rotational shaft of a generator (not depicted).

With the above configuration, when the working fluid having a high temperature and a high pressure is supplied into the casing of the turbine 62 from the combustor 63, the working fluid expands in the casing and thereby the main shaft 64 rotates, and a non-depicted generator connected to the gas turbine 6 is driven. That is, the pressure is reduced by the stationary vanes 5 fixed to the casing, and the kinetic energy generated thereby is converted into rotational torque via rotor blades 4 mounted to the main shaft 64. Further, the generated rotation torque is transmitted to the main shaft 64, and the generator is driven.

Normally, a heat-resistant alloy (e.g. IN738LC; commercial alloy material offered by Inco Limited) is used as a material of gas turbine rotor blades, and another heat-resistant alloy e.g. IN939; commercial alloy material offered by Inco Limited) is used as a material of gas turbine stationary vanes. That is, as a material of a turbine blade/vane, used is a heat-resistant alloy that can be used as the base material 11 in the ceramic coating 10 according to some embodiments described above. Thus, by applying the above ceramic coating 10 according to some embodiments described above to the turbine blades/vanes, it is possible to obtain a turbine blade/vane having a high thermal barrier effect and an anti-corrosion property. Thus, it is possible to use the turbine blades/vanes in an environment with a higher temperature, and obtain long-life turbine blades/vanes. Further, if the ceramic coating 10 is applicable under an environment with a higher temperature, it means it is possible to increase the temperature of the working fluid, and thus it is possible to improve the gas turbine efficiency.

Accordingly, the turbine blades 4, 5 being turbine members according to some embodiments include ceramic coating 10 according to some embodiments described above, and it is possible to improve the durability of turbine members even under an environment in Which corrosive substances exist.

Further, the gas urine 6 according to some embodiments include turbine blades 4, 5 being the above turbine members, and thus it is possible to improve the durability of turbine members in the gas turbine 6 even under an environment where combustion gas contains corrosive substances.

Embodiments of the present invention were described in detail above, but the present invention is not limited thereto, and various amendments and modifications may be implemented.

For instance, the method of producing a ceramic coating according to some embodiments described above includes a ceramic-layer forming step S10, a molten-and-solidified layer forming step S20, and a slurry applying step S30. However, if the ceramic layer 13 is thick enough, the molten-and-solidified layer forming step S20 and the slurry applying step S30 may be performed on the ceramic coating 10 having the packed layer 16 after being worn due to usage, to recover the thickness of the molten-and-solidified layer 14 having the packed layer 16.

Further, if the ceramic coating 10 not including the above described packed layer 16 in advance or the ceramic coating 10 not including the above described molten-and-solidified layer 14 and the above described packed layer 16 in advance is worn due to usage, the above-described molten-and-solidified layer forming step S20 and the slurry applying step S30 may be performed on the ceramic coating 10, to form the molten-and-solidified layer 14 and the packed layer 16 again. In this case, the above described ceramic layer forming step S10 may not necessarily be performed.

### DESCRIPTION OF REFERENCE NUMERALS

4 Gas turbine rotor blade
5 Gas turbine stationary vane
6 Gas turbine
10 Ceramic coating
11 Heat-resistant base material
12 Metallic bond layer (bond coat layer)
13 Ceramic layer
13a Surface layer portion
14 Molten-and-solidified layer
15 Crack (vertical crack)
16 Packed layer
17 Ceramic particle
18 Slurry

1. A ceramic coating, comprising:
a ceramic layer;
a molten-and-solidified layer formed on a surface of the ceramic layer; and
a packed layer including ceramic packed in a crack which extends in a thickness direction of the molten-and-solidified layer.

2. The ceramic coating according to claim 1,
wherein the ceramic layer has a porosity rate of no less than 1% and no more than 30%.

3. The ceramic coating according to claim 1,
wherein the packed layer includes ceramic particles having a 50% cumulative-distribution particle diameter of no more than 5 micrometers.

4. The ceramic coating according to claim 1,
wherein the molten-and-solidified layer has a thickness of no less than 5 micrometers and no more than 100 micrometers.

5. The ceramic coating according to claim 1,
wherein the packed layer comprises the same material as the ceramic layer.

6. The ceramic coating according to claim 5,
wherein the packed layer and the ceramic layer comprise yttria-stabilized zirconia.

7. The ceramic coating according to claim 1,
wherein the molten-and-solidified layer is a layer comprising a surface layer portion of the ceramic layer, the surface layer portion being solidified after being heated and molten.

8. A turbine member including the ceramic coating according to claim 1.

9. A gas turbine including the turbine member according to claim 8.

10. A method of producing a ceramic coating, comprising;
forming a ceramic layer;
forming a molten-and-solidified layer having a vertical crack by heating and melting a surface layer portion of the ceramic layer and then cooling the surface layer portion; and
applying a slurry containing ceramic particles to a surface of the molten-and-solidified layer.

11. The method of producing a ceramic coating according to claim 10, further comprising:
supplying the slurry to the vertical crack under a depressurized environment, after the applying of the slurry.

12. The method of producing a ceramic coating according to claim 10, further comprising:
firing the ceramic particles contained in the slurry existing in the vertical crack, after applying the slurry.

13. The method of producing a ceramic coating according to claim 10,
wherein the forming of the molten-and-solidified layer includes heating and melting the surface layer portion of the ceramic layer by emitting any one of laser, electric beam, or plasma.

14. The method of producing a ceramic coating according to claim 10,
wherein the forming of the ceramic layer includes forming the ceramic layer having a porosity rate of no less than 1% and no more than 30%.

15. The method of producing, a ceramic coating according to claim 11,
wherein the supplying of the slurry to the vertical crack under the depressurized environment includes replacing the slurry with an which remains in the vertical crack, by vacuuming air remaining in the vertical crack in a depressurization chamber.

16. The method of producing a ceramic coating according to claim 10, further comprising heating and drying the slurry applied to the surface of the molten-and-solidified layer.

17. A method of repairing a ceramic coating, comprising:
forming a molten-and-solidified layer having a vertical crack by heating and melting a surface layer portion of a ceramic layer and then cooling the surface layer portion; and
applying slurry containing ceramic particles to a surface of the molten-and-solidified layer.
